(19) United States
(12) Patent Application Publication
(10) Pub. No.: US 2025/0131282 A1
(43) Pub. Date: Apr. 24, 2025

(54) METHOD AND APPARATUS FOR ONLINE CONTINUAL LEARNING BY USING SHORTCUT DEBIASING

(71) Applicant: KOREA ADVANCED INSTITUTE OF SCIENCE AND TECHNOLOGY, Daejeon (KR)

(72) Inventors: Jae-Gil LEE, Daejeon (KR); Doyoung KIM, Daejeon (KR); Dongmin PARK, Daejeon (KR); Yooju SHIN, Daejeon (KR); Hwanjun SONG, Daejeon (KR)

(21) Appl. No.: 18/535,093

(22) Filed: Dec. 11, 2023

(30) Foreign Application Priority Data
Oct. 20, 2023 (KR) 10-2023-0141098

(51) Int. Cl. G06N 3/096

(52) U.S. Cl. CPC G06N 3/096

(57) ABSTRACT

Disclosed is an operating method of an apparatus operated by at least one processor, the operating method including: fusing at least some feature maps generated by layers of a target model performing online continual learning to generate a fused feature map; identifying features with high attention in the fused feature map as shortcut features in a ratio based on a drop intensity; and removing the shortcut features from a target feature map output from a predetermined layer of the target model and input to a next layer.

### CROSS-REFERENCE TO RELATED APPLICATION

This application claims priority to and the benefit of Korean Patent Application No. 10-2023-0141098 filed in the Korean Intellectual Property Office on Oct. 20, 2023, the entire contents of which are incorporated herein by reference.

### BACKGROUND

### (a) Field

The present disclosure relates to Online Continual Learning (OCL).

### (b) Description of the Related Art

Deep neural networks (DNNs) often rely on a strong correlation between peripheral features, which are easy-to-learn, and target labels during the learning process. Such peripheral features and learning bias are called shortcut features and shortcut bias. For example, DNNs may extract only shortcut features, such as color, texture, and local or background cues. For example, when classifying dogs and birds, only the legs (i.e., local cue) and sky (i.e., background cue) could be extracted if they are the easiest to distinguish between the two classes. The shortcut bias is an important problem in most computer vision themes such as image classification

Online continual learning (OCL) for image classification maintain a DNN to classify images from an online stream of images and tasks, and in general. Due to the characteristics of the online environment, there is not abundant training data, and the computational and memory budgets are typically tight. This limited opportunity for learning exacerbates the shortcut bias in OCL, because DNNs tend to learn easy-to-learn features early on.

The shortcut bias hinders the main goal of OCL that solves the plasticity and stability dilemma for high transferability and low catastrophic forgetting. That is, it incurs low transferability and high forgetting in OCL, because shortcut features do not generalize well to unseen new classes and are no longer discriminative for all classes. For example, when an OCL model learns to use the sky that is the background as a shortcut feature for the current task, it is faced with a bad initial point for the future task. Further, when an OCL model learns to use the dog's legs for the current task, it is forced to forget the prior knowledge about the legs due to the misclassification of the animals other than the dog.

In the meantime, research on a shortcut debiasing method has been conducted. Representative debiasing methods require the prior knowledge of a target task to predefine the undesirable bias for unseen conditions or leverage auxiliary data, such as out-of-distribution (OOD) data. However, in OCL, because future tasks are inherently unknown and access to auxiliary data is constrained due to limited memory budget, there is a limitation that the existing debiasing method that uses prior knowledge or auxiliary data cannot be used.

### SUMMARY

The present disclosure attempts to provide an online continual learning method and apparatus for suppressing shortcut bias without prior knowledge and auxiliary data by removing shortcut features identified via feature map fusion.

An exemplary embodiment of the present disclosure provides an operating method of an apparatus operated by at least one processor, the operating method including: fusing at least some feature maps generated by layers of a target model performing online continual learning to generate a fused feature map; identifying features with high attention in the fused feature map as shortcut features in a ratio based on a drop intensity; and removing said shortcut features from a target feature map output from a predetermined layer of said target model and input to a next layer.

The next layer of the predetermined layer may receive a feature map with the shortcut features removed as input, so that shortcut debiasing online continual learning may be progressed in the target model.

The removing the shortcut features may include removing the shortcut features from the target feature map by applying a drop mask that masks regions of the shortcut features in the target feature map with zero.

The generating the fused feature map may include fusing a first feature map including structural information with a second feature map including semantic information.

The generating of the fused feature map may include adjusting said first feature map and said second feature map to have the same resolution and then fusing the first feature map and the second feature map.

The identifying the shortcut features may include: performing pooling on said fused feature map along channel dimension to generate an attention map; identifying a certain percentage of features with high attention scores in said attention map as said shortcut features based on said drop intensity; and generating a drop mask that masks regions of the shortcut features in the attention map with zero.

The operating method may further include adaptively shifting the drop intensity.

The adaptively shifting the drop intensity may include periodically determining whether decrement or increment of a current drop intensity is beneficial to prediction performance of the target model, and increasing or decreasing a next drop intensity from the current drop intensity, or maintaining the current drop intensity.

The adaptively shifting the drop intensity may include comparing loss reduction according to a reduced drop intensity and loss reduction according to an increased drop intensity while alternately using the reduced drop intensity and the increased drop intensity for a certain number of iterations, and updating the current drop intensity in a significantly better direction of the loss reduction.

Another exemplary embodiment of the present disclosure provides an apparatus for online continual learning, the apparatus including: a memory; and a processor executing instructions stored in the memory, wherein the processor is configured, by executing the instructions, to fuse at least some feature maps generated by layers of a target model performing online continual learning to generate a fused feature map, identify features with high attention in the fused feature map as shortcut features in a ratio based on a drop intensity, and remove the shortcut features from a target feature map output from a predetermined layer of the target model and input to a next layer.

The next layer of the predetermined layer may receive a feature map with the shortcut features removed as input, so that shortcut debiasing online continual learning may be progressed in the target model.

The processor may be configured to remove the shortcut features from the target feature map by applying a drop mask that masks regions of the shortcut features in the target feature map with zero.

The processor may be configured to fuse a first feature map including structural information with a second feature map including semantic information.

The processor may be configured to adjust said first feature map and said second feature map to have the same resolution and then fuses the first feature map and the second feature map.

The processor may be configured to perform pooling on said fused feature map along a channel to generate an attention map, identify a certain percentage of features with high attention scores in said attention map as said shortcut features based on said drop intensity, and generate a drop mask that masks regions of the shortcut features in the attention map with zero.

The processor may be configured to adaptively shift the drop intensity.

The processor may be configured to periodically determine whether decrement or increment of a current drop intensity is beneficial to prediction performance of the target model, and increase or decrease a next drop intensity from the current drop intensity, or maintain the current drop intensity.

The processor may be configured to compare loss reduction according to a reduced drop intensity and loss reduction according to an increased drop intensity while alternately using the reduced drop intensity and the increased drop intensity for a certain number of iterations, and update the current drop intensity in a significantly better direction of the loss reduction.

Still another exemplary embodiment of the present disclosure provides a computer program stored in a non-transitory computer-readable storage medium, the computer program including instructions that, when executed by at least one processor, cause the processor configured to fuse at least some feature maps generated by layers of a target model performing online continual learning to generate a fused feature map, perform pooling on said fused feature map along a channel to generate an attention map, identify a certain percentage of features with high attention scores in said attention map as said shortcut features based on said drop intensity, generate a drop mask that masks regions of the shortcut features in the attention map with zero, and apply the drop mask to a target feature map output from a predetermined layer of said target model, and input a new target feature map with shortcut features removed into a next layer of said predetermined layer.

The computer program may further include instructions to cause the processor configured to periodically determine whether decrement or increment of a current drop intensity is beneficial to prediction performance of the target model, and increase or decrease a next drop intensity from the current drop intensity, or maintain the current drop intensity.

According to the present disclosure, it is possible to provide high transferability and low catastrophic forgetting, which are goals of online continual learning, by suppressing shortcut bias without the need for prior knowledge and auxiliary data.

According to the present disclosure, even in an online environment with insufficient training data and limited computing and memory resources, the shortcut bias may be suppressed, the present disclosure may be applied to various existing OCL models and improve the performance of the online continual learning model.

### BRIEF DESCRIPTION OF THE DRAWINGS

FIG. 1 is a conceptual diagram of an online continual learning apparatus according to an embodiment.

FIG. 2 is a diagram illustrating drop mask-based shortcut debiasing according to an embodiment.

FIG. 3 is an example of drop mask generation according to an embodiment.

FIG. 4 is a diagram conceptually illustrating adaptive drop intensity adjustment according to an embodiment.

FIG. 5 is a diagram conceptually illustrating drop intensity update according to an embodiment.

FIGS. 6 and 7 are each diagrams illustrating a debiasing effect according to an embodiment.

FIG. 8 is a flow diagram of a shortcut debiasing method according to an embodiment.

FIG. 9 is a flow diagram of a shortcut debiasing method according to an embodiment.

FIG. 10 is a hardware diagram of an imaging device according to an embodiment.

### DETAILED DESCRIPTION OF THE EMBODIMENTS

Hereinafter, exemplary embodiments of the present invention will be described with reference to accompanying drawings so as to be easily understood by a person ordinary skilled in the art. The present invention can be variously implemented and is not limited to the following exemplary embodiments. In addition, in order to clearly explain the present description in the drawings, parts irrelevant to the description are omitted, and similar parts are denoted by similar reference numerals throughout the specification.

In the description, reference numerals and names are for convenience of description only, and devices are not necessarily limited to the reference numerals or names.

In addition, unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

An apparatus of the present disclosure is a computing device configured and connected so that at least one processor performs the operations of the present disclosure by executing instructions. A computer program may include instructions that cause a processor to execute the operations of the present disclosure and may be stored on a non-transitory computer readable storage medium. The computer program may be downloaded through a network or sold as a product.

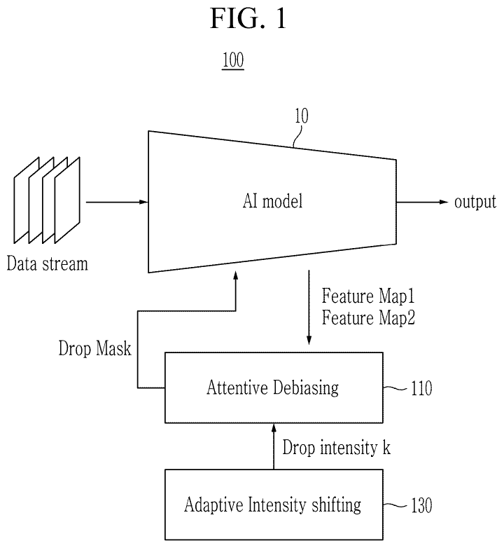

FIG. 1 is a conceptual diagram of an online continual learning apparatus according to an embodiment.

Referring to FIG. 1, an Online Continual Learning (OCL) apparatus 100 is a computing device operated by at least one processor to train an Artificial Intelligence (AI) model 10 that is a target model for online continual learning. The online continual learning apparatus 100 is configured to support online continual learning of the AI model 10 by suppressing shortcut bias without prior knowledge and auxiliary data.

The online continual learning apparatus 100 may include a memory storing instructions of a computer program, and at least one processor executing the instructions, and the processor may execute the instructions to perform shortcut debiasing and online continual learning operations of the present disclosure. A computer program includes instructions stored on a computer-readable storage medium and executed by a processor.

The AI model 10 may be an online continual learning model that makes task-dependent predictions (for example, classification) from an online data stream. The structure of the AI model 10 may vary, for example, it may be implemented as a Deep Neural Network (DNN) including a plurality of layers, a Convolutional Neural Network (CNN), a transformer, or the like. The description uses DNNs as an example, but the present disclosure is not limited thereto. Further, the AI model 10 to which the shortcut debiasing method of the present disclosure is applicable may include an already known online continual learning model.

First, the online continual learning will be described first. In an online environment, tasks with new classes appear in succession. In this case, each instance of data may typically be accessed only once, unless it is stored in the memory. For the t^{th} task, a data stream Dₜ={(xₜⁱ, yₜⁱ)}ᵢ₌₁^{i=m}^{ₜ} may be obtained from the data distribution Xₜ×Yₜ. Xₜ is the input space, Yₜ is the label space, and mₜ is the number of instances of the t^{th} task. The goal of online continual learning may be to train a classifier to maximize the test accuracy of all known tasks T={1, 2, . . . , t} at a specific point in time in a state where there is no access to the data stream or only a limited access to the data stream of the previous tasks is possible.

The AI model 10 that performs online continual learning may include a feature extractor and a classifier layer. It is assumed that the AI model 10 has a bias for shortcut features that can easily distinguish between given classes.

Here, a feature may be called a shortcut feature when the feature is not only highly active on seen data instances, but also unintentionally active on unseen data instances. For example, a shortcut feature, such as an animal's legs, is not an intrinsic feature and may be observed from unseen instances. On the other hand, when a feature is highly active only for the seen data instances, the feature may be called as a non-shortcut feature.

Due to the simplicity bias of the AI model 10, shortcut features tend to have higher activation values than non-shortcut features. Depending on the nature of these shortcut features, the online continual learning apparatus 100 may remove features with high activation values, that is, features with high attention, to prevent the features from being used in the training process of the AI model 10, resulting in preventing the AI model 10 from easily learning using the shortcut features.

Specifically, the online continual learning apparatus 100 may remove shortcut features that are activated during the online continual learning process of the AI model 10 and have high attention. The online continual learning apparatus 100 may remove the shortcut features while adaptively varying the ratio of the removal of the features depending on the shortcut bias varying depending on the task and the learning progress. To this end, the online continual learning apparatus 100 may include an attentive debiasing module 110 and an adaptive intensity shifting module 130. Here, the attentive debiasing module 110 and the adaptive intensity shifting module 130 are intended to illustrate the debiasing operation and the drop intensity shifting operation for the debiasing operation separately, and do not necessarily need to be implemented separately. The shortcut debias method of the present disclosure may be called ‘DropTop’.

The attentive debiasing module 110 may remove features that are expected to be shortcuts from the feature map, based on the drop intensity κ adjusted in the adaptive intensity shifting module 130 via feature map fusion. The feature map with the expected shortcut features removed is then input into the network of the AI model 10, so that the learning bias caused by the shortcut features may be suppressed. While the attentive debiasing module 110 is running during the learning process, the drop intensity κ may be periodically adjusted by the adaptive intensity shifting module 130.

In the case of the AI model 10 composed of multiple layers, such as a DNN, an individual feature map is output from each layer and is sequentially input to the next layer. The shortcut features may be identified through at least one feature map generated from these layers. The attentive debiasing module 110 may integrate structural features and semantic high-level features via feature map fusion to account for both features from a lower-level layer and features from a high-level layer. For example, when feature map 1 and feature map 2 are used for shortcut feature identification, the features maps generated by the first layer and the last layer may be selected. However, the number of feature maps to be fused can increase, and the layers that provide them can be selected in a variety of ways.

It is assumed that the attentive debiasing module 110 fuses the feature maps output from different layers of the target model, the AI model 10, for example, the first layer and the last layer, to generate a fused feature map f_{fuse}. To match the resolution of the feature maps output from the first layer and the last layer, the attentive debiasing module 110 may upsample the feature map of the last layer and adjust the feature map of the last layer to have the same resolution as the feature map of the first layer, and then fuse the feature maps. The attentive debiasing module 110 may then perform pooling of the fused feature maps along the channel dimension to generate a two-dimensional attention map.

Also, because the DNN prefers to learn shortcut features that are easy to learn initially, shortcut features tend to be activated and have high attention scores. Thus, the attentive debiasing module 110 may determine features with attention scores in the top κ % in the attention map as candidate shortcut features. In consideration of the nature of the shortcut bias having high attention, the attentive debiasing module 110 may consider highly activated features as candidate shortcut features for debiasing.

Given a drop intensity κ % for each class, the attentive debiasing module 110 generates a drop mask M that masks the features with the top κ % attention in the attention map A_{fuse} generated by the feature map fusion with zero. As represented in Equation 1, the drop mask M_{i,j} at position (i, j) in the drop mask M may be determined to be 0 or 1 depending on whether the attention value at position (i, j) is in the top κ %. top-κ (A_{fuse}) may return the set of the top κ % of elements in the attention map A_{fuse}.

$${M}_{i , j} = \{ \begin{matrix}0 , & if ( i , j ) ∈ top - κ ( {A}_{fuse} ) \\ 1 , & otherwise\end{matrix} \qquad ( Equation 1 )$$

The drop mask M may be applied to a predetermined feature map generated by the network of the AI model 10. For example, as shown in Equation 2, the drop mask M may be applied to a feature map F_{first} generated from the first layer after the stem layer of the AI model 10, such as ResNet or Vision Transformer. The feature map \tilde{F}_{first} to which the drop mask is applied is input to the next layer, so that all subsequent layers are affected by the feature map with the shortcut features removed. This allows the AI model 10 to learn to predict the output from the feature map \tilde{F}_{first} without the shortcut features.

$${\tilde{F}}_{first} = M ⊙ {F}_{first} \qquad ( Equation 2 )$$

On the other hand, high attention features include not only shortcut features but also non-shortcut features. The degree of shortcut bias may also change depending on the task and learning progress. Therefore, it is very important to determine how many shortcut features are present among the high attention features. The adaptive intensity shifting module 130 may guide the degree of debiasing by a method of appropriately adjusting the drop intensity κ at an appropriate point in time.

The adaptive intensity shifting module 130 may decrease the drop intensity κ when it is expected to lose the important non-shortcut feature that are relevant to prediction performance due to the removal of the features with high attention, increase the drop intensity κ when it is expected to emphasize the important non-shortcut feature due to the removal of the features with high attention, and not change the drop intensity κ when the case does not corresponding to two cases. The adaptive intensity shifting module 130 may vary the drop intensity κ as shown in Equation 1. In Equation 3, κ′ is the previous value and a (<1.0) is a hyperparameter representing the shift step.

$$κ ← \{ \begin{matrix}{κ}^{′} * α & if decrement \\ {κ}^{′} * ( \frac{1}{α} ) & if decrement \\ {κ}^{′} & otherwise\end{matrix} \qquad ( Equation 3 )$$

For example, when the features with the top κ % of attention scores include many shortcut features (for example, background), the adaptive intensity shifting module 130 may increase κ to actively delete the shortcut features, or vice versa, decrease K to avoid removing useful features that are relevant to prediction performance.

The adaptive intensity shifting module 130 may determine a loss reduction ΔL by alternately using the reduced drop intensity κ^{dec} (=κ′*α) and the increased drop intensity κ^{inc} (=κ′/α) every p iterations in order to determine whether the drop intensity decrement or the drop intensity increment is preferred.

The loss reduction ΔL may be calculated every p iterations and stored in memory H^{dec} when κ^{dec} is used and stored in memory H^{inc} when κ^{inc} is used. The loss reduction may follow the memory constraints of online continual learning in that each set is written to have 1 elements, and only a single model is needed to compare the two shift directions.

When H^{dec} and H^{inc} are full every 2*p*1 iterations, the adaptive intensity shifting module 130 may perform a t-test to evaluate whether the difference between the two directions in the loss reduction is statistically significant. The adaptive intensity shifting module 130 may update the previous value κ in the better direction when a statistically significant better direction (increment or decrement) exists, otherwise the adaptive intensity shifting module 130 may keep the previous value κ as is.

If the drop intensity changes over time, the distribution of input features could be swayed inconsistently. This problem causes training instability and eventually deteriorates the overall performance. Thus, γ that drop intensity κ cannot exceed beyond may be set, and if κ<γ, the attentive debiasing module 110 may additionally choose and delete (γ−κ) % of the features uniformly at random among features whose drop mask is not 1.

In this way, the online continual learning apparatus 100 may suppress shortcut bias in online continual learning, and adapt to various shortcut biases that arise due to the constantly changing environment at the same time. By automatically determining the appropriate level and proportion of shortcut features to delete through feature map fusion and adaptive intensity shifting, the online continual learning apparatus 100 may conduct shortcut debiasing in online environments where prior knowledge and auxiliary data are not available. The shortcut debiasing method of the present disclosure may be applied to various types of online continual learning to improve learning performance.

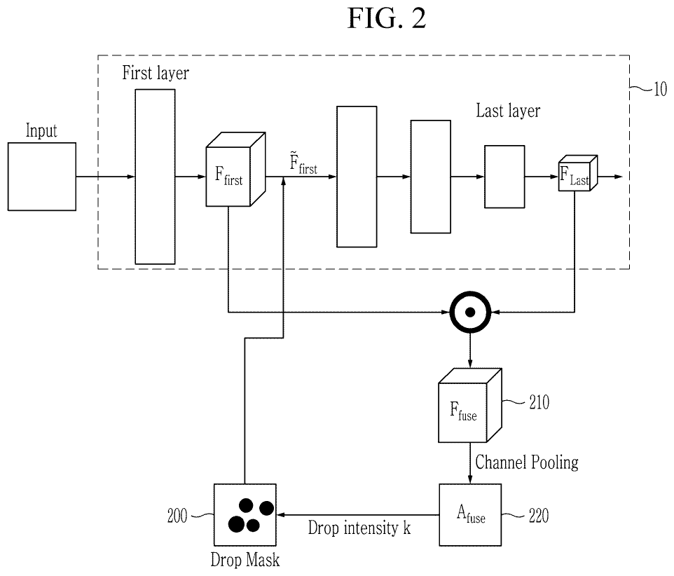

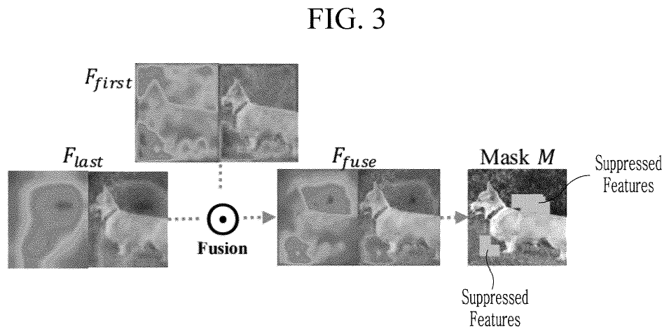

FIG. 2 is a diagram illustrating drop mask-based shortcut debiasing according to an embodiment, and FIG. 3 is an example of drop mask generation according to an embodiment.

Referring to FIG. 2, the attentive debiasing module 110 generates a drop mask 200 that may remove shortcut features from the feature map generated from the input data to prevent the AI model 10 from learning using the shortcut features. The drop mask 200 may be applied to a predetermined feature map generated from the layers of the AI model 10, for example, to the feature map F_{first} generated from the first layer of the AI model 10. Then, the new feature map \tilde{F}_{first} with the drop mask 200 applied to the 30 feature map F_{first} is input as the next layer, so that all subsequent layers may be trained under the influence of the feature map without the shortcut features.

The attentive debiasing module 110 determines features with high attention scores from the at least one feature map generated from the layers of the AI model 10 as shortcut features, and masks regions corresponding to the shortcut features to generate a drop mask 200. In general, features extracted from higher layers include discriminative information but lack detailed information, such as object boundaries, while features extracted from lower layers include structural information. Thus, to reduce ambiguity in identifying regions of shortcut features, a feature map F_{fuse} 210 may be generated that fuses structural features and semantic high-level features. The attentive debiasing module 110 may determine the number of feature maps to fuse based on memory space. For example, when memory space is limited, the attentive debiasing module 110 may fuse the feature maps output from the first layer and the last layer to generate a fused feature map F_{fuse} 210. To match the resolution of the feature maps output from the first layer and the last layer, the attentive debiasing module 110 may upsample the feature map of the last layer and adjust the feature map of the last layer to have the same resolution as the feature map of the first layer, and then fuse the feature maps.

The attentive debiasing module 110 performs pooling the fused feature map F_{fuse} 210 along the channel dimension to generate an attention map A_{fuse} 220.

Given a drop intensity κ for each class, the attentive debiasing module 110 generates a drop mask 200 that masks features with top κ % attention scores in the attention map A_{fuse} 220 with zero.

Referring to FIG. 3, the attentive debiasing module 110 may generate a feature map F_{fuse} that is a fusion of F_{first}, which includes structural features, such as boundaries, and Fₗₐₛₜ, which includes semantic features. The fused feature map F_{fuse} may be used to identify a background that is a shortcut feature from the high-level features on important parts, such as the body of the dog.

The attentive debiasing module 110 may consider the highly activated features as shortcut features based on the drop intensity κ, and generate a drop mask to remove the shortcut features from the feature map.

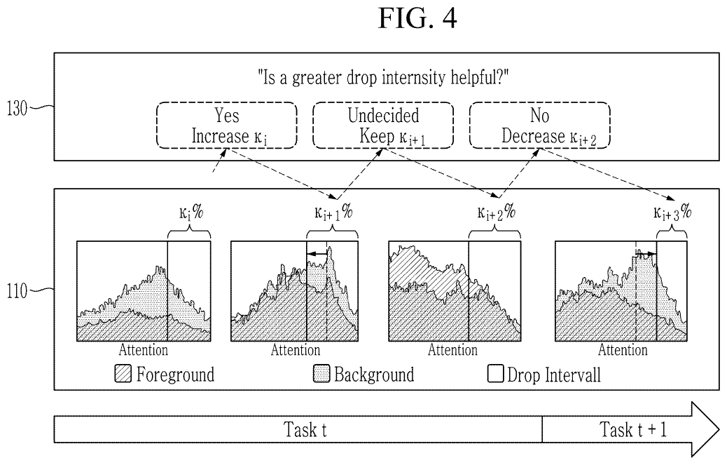

FIG. 4 is a diagram conceptually illustrating adaptive drop intensity adjustment according to an embodiment.

Referring to FIG. 4, the attentive debiasing module 110 may determine the top κ % of features with high attention scores as shortcut features to be removed, based on the drop intensity κ adjusted by the adaptive intensity shifting module 130. In this case, the features with high attention include shortcut features as well as non-shortcut features, and the degree of shortcut bias may change with task and learning progress. Thus, instead of using a fixed drop intensity κ, the drop intensity κ may be adjusted appropriately with the help of the adaptive intensity shifting module 130 to increase, decrease, or maintain the top κ % to be removed.

The adaptive intensity shifting module 130 may decrease the drop intensity κ when the removal of features with high attention is expected to result in the loss of important non-shortcut features that are relevant to prediction performance, increase the drop intensity κ when the removal of features with high attention is expected to help emphasize important non-shortcut features, and not change the drop intensity κ when the case does not correspond to the two cases.

For example, when the top κᵢ % of the i^{th} attention map includes a lot of background that is a shortcut feature, the adaptive intensity shifting module 130 may determine a next drop intensity κᵢ₊₁ that is greater than κᵢ because it is helpful to remove more of the top features. Further, the adaptive intensity shifting module 130 may determine a next drop intensity κᵢ₊₂ that maintains κᵢ₊₁ when it is difficult to determine whether removing more or less than the top κᵢ₊₁% of features in the i+1^{st} attention map is helpful. Next, when the top κᵢ₊₂% of the i+2^{nd} attention map includes a lot of foreground that is the non-shortcut feature, it is helpful to remove fewer of the top features, so that the adaptive intensity shifting module 130 may determine the next drop intensity κᵢ₊₃, which is a decrease from κᵢ₊₂. The intensity of the next drop may be increased or decreased depending on a given value of α (<1.0), as shown in Equation 3.

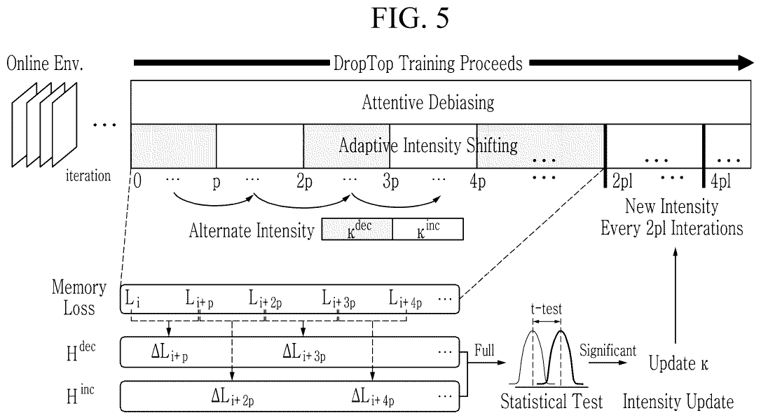

FIG. 5 is a diagram conceptually illustrating drop intensity update according to an embodiment.

Referring to FIG. 5, the adaptive intensity shifting module 130 may determine whether reducing or increasing the current drop intensity κ will benefit the predictive performance of the model, and may increase or decrease the next drop intensity from the current drop intensity, or maintain the current drop intensity.

The adaptive intensity shifting module 130 may determine the loss reduction ΔL by alternately using the reduced drop intensity κ_{dec} (=κ′*a) and the increased drop intensity κ^{inc} (=κ′/α) every p iterations. Herein, p is set to be long enough to observe stable behavior with respect to each κ option.

Referring to Equation 4, the loss reduction ΔL may be calculated every p iterations and stored in memory H^{dec} when κ^{dec} is used and stored in memory H^{inc} when κ^{inc} is used.

$${H}^{dec} = \{ Δ {L}_{0} , Δ {L}_{2 p} , … , Δ \text{?} \} \qquad ( Equation 4 )$$

$$and$$

$${H}^{inc} = {\underbrace{\{ Δ {L}_{p} , Δ {L}_{3 p} , … , Δ \text{?} \}}}_{Collect Δ {L}_{p} every 2 p iterations}$$

$$\text{?} \text{indicates text missing or illegible when filed}$$

In Equation 4, L_{(q+1)p} is the predicted cross-entropy for the samples of a specific class stored in the memory buffer at the iteration (q+1)p. ΔL_{(q+1)p} is the difference between L_{qp} and L_{(q+1)p}. In the meantime, the loss may be calculated by using the samples in the memory buffer rather than in a batch to obtain a more generalizable training loss. Those loss reductions are recorded until each set has 1 elements, and only a single model is needed to compare two shift directions, preserving the memory constraint of online continual learning.

When H^{dec} and H^{inc} are full every 2*p*1 iterations, the adaptive intensity shifting module 130 may perform a t-test to evaluate whether the difference between the two directions in the loss reduction is statistically significant. The adaptive intensity shifting module 130 may update the previous value κ in the better direction when a statistically significant better direction (increment or decrement) exists, otherwise the adaptive intensity shifting module 130 may keep the previous value κ as is.

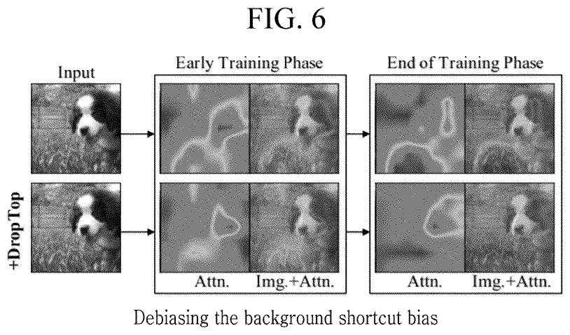

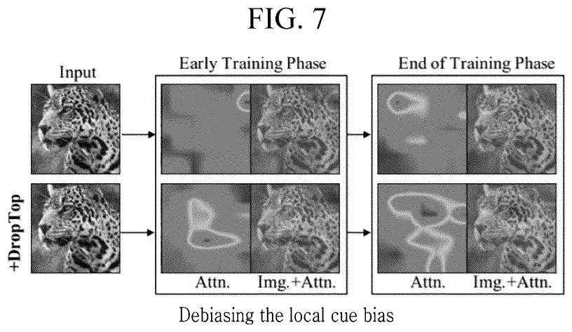

FIGS. 6 and 7 are each diagram illustrating a debiasing effect according to an embodiment.

Referring to FIGS. 6 and 7, to qualitatively analyze the effect of the shortcut debiasing method ‘DropTop’ of the present disclosure, on Split ImageNet-9, the activation maps obtained from the model (second row) trained by applying the shortcut debiasing method ‘DropTop’ of the present disclosure may be compared with the model using no DropTop (first row).

It can be observed that the model using ‘DropTop’, the shortcut debiasing method of the present disclosure, gradually mitigates the shortcut bias as learning progresses, while the original model increasingly relies on shortcut features (background in FIG. 5 and local cues in FIG. 6).

In FIG. 6, the model using the shortcut debiasing method ‘DropTop’ of the present disclosure is able to successfully debias the grass background as the model's training progresses, eventually focusing on the intrinsic shapes of the dog at the end of the training. In the meantime, it can be seen that the model not-using the shortcut debiasing method ‘DropTop’ of the present disclosure rather intensifies the reliance on the background as the model's training progresses.

In FIG. 7, the model using the shortcut debiasing method ‘DropTop’ of the present disclosure is able to successfully debias local cues as the model's training progresses, and gradually expanding the extent of the discriminative region to recognize the overall shape of the object, resulting in a more accurate and comprehensive recognition of the leopard.

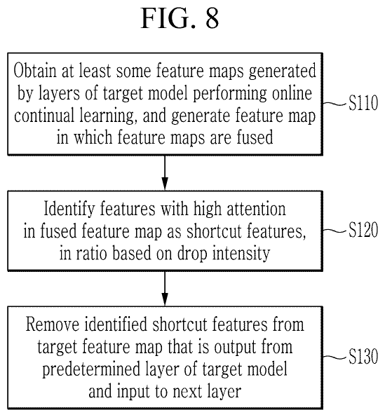

FIG. 8 is a flow diagram of a shortcut debiasing method according to an embodiment.

Referring to FIG. 8, the online continual learning apparatus 100 obtains at least some feature maps generated by the layers of the target model performing online continual learning, and generates a feature map in which the feature maps are fused (S110). The online continual learning apparatus 100 may determine the number of feature maps to fuse based on memory space, and may, for example, fuse a feature map including structural information with a feature map including semantic information. To fuse feature maps with different resolution, the online continual learning apparatus 100 may adjust the feature maps to have the same resolution through upsampling and the like, and then fuse the feature maps.

The online continual learning apparatus 100 identifies features with high attention in the fused feature map as shortcut features, in a ratio based on drop intensity (S120). Given a drop intensity κ, the online continual learning apparatus 100 may identify features that are in the top κ % of attention as shortcut features. In this case, the online continual learning apparatus 100 may periodically determine during the training process whether decrement or increment of the current drop intensity κ is beneficial to the prediction performance of a target model, and may increase or decrease the next drop intensity from the current drop intensity, or maintain the current drop intensity. Specifically, the online continual learning apparatus 100 may store the loss reduction based on a reduced drop intensity and the loss reduction based on an increased drop intensity in separate memories while alternately using the reduced drop intensity and the increased drop intensity for a certain number of iterations, and then periodically determine whether a significantly better direction (increase or decrease) of the loss reduction exists, and update a previous value κ to the better direction (increment or decrement), or maintain the previous value κ as is.

The online continual learning apparatus 100 removes the identified shortcut features from the target feature map that is output from a predetermined layer of the target model and input to a next layer (S130). The next layer of the predetermined layer receives a feature map with the shortcut features removed as input, so that the shortcut debiasing online continual learning may be progressed in the target model. To ensure that as many layers as possible are trained by using shortcut debiased features, the online continual learning apparatus 100 may remove shortcut features from the feature map output from a lower layer (for example, the first layer) so that all subsequent layers may be trained under the influence of the feature map with the shortcut features removed. The online continual learning apparatus 100 may remove the shortcut features by applying a drop mask that masks the regions of the identified shortcut features with zeros to the feature map.

The online continual learning apparatus 100 includes a processor executing instructions, and the processor may, by executing the instructions, obtain at least some feature maps generated by the layers of the target model performing online continual learning, generate a feature map in which the feature maps are fused, identify features with high attention in the fused feature map as shortcut features in a ratio based on drop intensity, and remove the identified shortcut features from the target feature map that is output from a predetermined layer of the target model and input to the next layer.

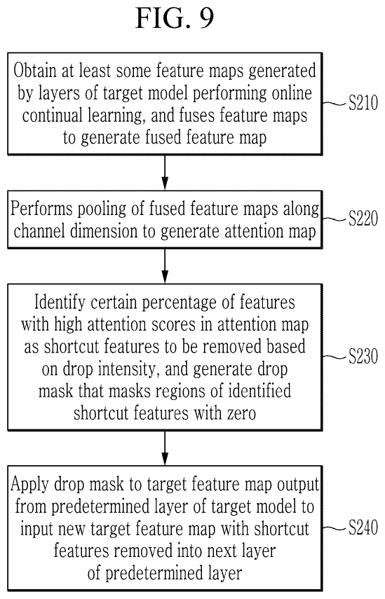

FIG. 9 is a flow diagram of a shortcut debiasing method according to an embodiment.

Referring to FIG. 9, the online continual learning apparatus 100 obtains at least some feature maps generated by layers of a target model performing online continual learning, and fuses the feature maps to generate a fused feature map (S210). The online continual learning apparatus 100 may determine the number of feature maps to fuse based on memory space, and may, for example, fuse a feature map including structural information with a feature map including semantic information. To fuse feature maps with different resolution, the online continual learning apparatus 100 may adjust the feature maps to have the same resolution through upsampling and the like, and then fuse the feature maps.

The online continual learning apparatus 100 performs pooling of the fused feature maps along the channel dimension to generate an attention map (S220).

The online continual learning apparatus 100 identifies a certain percentage of features with high attention scores in the attention map as shortcut features to be removed based on drop intensity, and generates a drop mask that masks the regions of the identified shortcut features with zero (S230). Given a drop intensity κ, the online continual learning apparatus 100 may generate a drop mask that masks features with an attention score in the top κ % in the attention map with zero. The drop intensity may be adaptively shifted. The online continual learning apparatus 100 may periodically determine during the training process whether decrement or increment of the current drop intensity κ is beneficial to the prediction performance of a target model, and may increase or decrease the next drop intensity from the current drop intensity, or maintain the current drop intensity. Specifically, the online continual learning apparatus 100 may store the loss reduction based on the reduced drop intensity and the loss reduction based on the increased drop intensity in separate memories while alternately using a reduced drop intensity and an increased drop intensity for a certain number of iterations, periodically determine whether a significantly better direction (increase or decrease) of the loss reduction exists, and update a previous value κ to the better direction (increment or decrement), or maintain the previous value κ as is.

The online continual learning apparatus 100 applies the drop mask to the target feature map output from the predetermined layer of the target model to input a new target feature map with the shortcut features removed into the next layer of the predetermined layer (S240).

The online continual learning apparatus 100 includes a processor executing instructions, and the processor may, by executing the instructions, obtain at least some feature maps generated by the layers of the target model performing online continual learning, fuses the feature maps to generate a fused feature map, performs pooling of the fused feature map along the channel dimension to generate an attention map, identify a certain percentage of features in the attention map with high attention scores based on drop intensity as shortcut features to be removed, generate a drop mask that masks the regions of the identified shortcut features with zero, and apply the drop mask to the feature map output from the predetermined layer of the target model, and input a new target feature map with the shortcut features removed as the next layer in the predetermined layer.

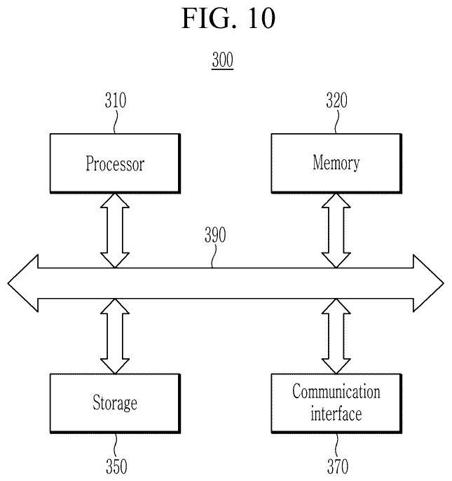

FIG. 10 is a hardware diagram of an imaging device according to an embodiment.

Referring to FIG. 10, the online continual learning apparatus 100 may be a computing device 300 operated by at least one processor. The computing device 300 may include one or more processors 310, a memory 330 for loading a computer program executed by the processor 310, a storage 350 for storing a computer program and various data, a communication interface 370, and a bus 390 connecting the components. In addition, the computing device 300 may further include various other components.

The processor 310 controls the overall operations of each configuration of the computing device 300. The processor 310 may include at least one of a Central Processing Unit (CPU), a Micro Processor Unit (MPU), a Micro Controller Unit (MCU), a Graphic Processing Unit (GPU), or any other form of processor well known in the art of the present disclosure. Further, the processor 310 may perform operations on at least one application or computer program for executing the method/operations according to various exemplary embodiments of the present disclosure.

The memory 330 stores various data, instructions, and/or information. The memory 330 may load one or more computer programs from the storage 350 to execute the method/operations according to various exemplary embodiments of the present disclosure. The memory 330 may be implemented as volatile memory, such as RAM, but the technical scope of the present disclosure is not limited thereto.

The storage 350 may store programs non-transitorily. The storage 350 may include a non-volatile memory, such as a Read Only Memory (ROM), an Erasable Programmable ROM (EPROM), an Electrically Erasable Programmable ROM (EEPROM), a flash memory, or the like, a hard disk, a removable disk, or any other form of computer-readable recording medium well known in the art to which the present disclosure belongs.

The communication interface 370 supports wired and wireless communication of the computing device 300. To this end, the communication interface 370 may be configured to include communication modules well known in the art of the present disclosure.

The bus 390 provides communication capabilities between components of the computing device 300. The bus 390 may be implemented as various types of buses, such as an address bus, a data bus, and a control bus.

A computer program may include instructions executed by the processor 310, and may be stored on a non-transitory computer readable storage medium, and the instructions cause the processor 310 to perform the method/operation according to various exemplary embodiments of the present disclosure. That is, by executing the instructions, the processor 310 may perform the method/operations according to various exemplary embodiments of the present disclosure. The instruction is a set of computer-readable instructions grouped by function, and is executed by a component of the computer program and the processor. The computer program may be downloaded through a network or sold as a product. As such, the present disclosure may provide high transferability and low catastrophic forgetting, which are goals of online continual learning, by suppressing shortcut bias without the need for prior knowledge and auxiliary data.

According to the present disclosure, even in an online environment with insufficient training data and limited computing and memory resources, the shortcut bias may be suppressed, the present disclosure may be applied to various existing online continual learning models and improve the performance of the online continual learning model.

The exemplary embodiments of the present disclosure described above are not only implemented through the apparatus and method, but may also be implemented through programs that realize functions corresponding to the configurations of the exemplary embodiment of the present disclosure, or through recording media on which the programs are recorded.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

What is claimed is:

1. An operating method of an apparatus operated by at least one processor, the operating method comprising:
fusing at least some feature maps generated by layers of a target model performing online continual learning to generate a fused feature map;
identifying features with high attention in the fused feature map as shortcut features in a ratio based on a drop intensity; and
removing the shortcut features from a target feature map output from a predetermined layer of the target model and input to a next layer.

2. The operating method of claim 1, wherein the next layer of the predetermined layer receives a feature map with the shortcut features removed as input, so that shortcut debiasing online continual learning is progressed in the target model.

3. The operating method of claim 1, wherein the removing the shortcut features includes
removing the shortcut features from the target feature map by applying a drop mask that masks regions of the shortcut features in the target feature map with zero.

4. The operating method of claim 1, wherein the generating the fused feature map includes
fusing a first feature map including structural information with a second feature map including semantic information.

5. The operating method of claim 4, wherein the generating the fused feature map includes
adjusting the first feature map and the second feature map to have the same resolution and then fusing the first feature map and the second feature map.

6. The operating method of claim 1, wherein the identifying the shortcut features includes:
performing pooling on the fused feature map along channel dimension to generate an attention map;
identifying a certain percentage of features with high attention scores in the attention map as the shortcut features based on the drop intensity; and
generating a drop mask that masks regions of the shortcut features in the attention map with zero.

7. The operating method of claim 1, further comprising
adaptively shifting the drop intensity.

8. The operating method of claim 7, wherein the adaptively shifting the drop intensity includes
periodically determining whether decrement or increment of a current drop intensity is beneficial to prediction performance of the target model, and increasing or decreasing a next drop intensity from the current drop intensity, or maintaining the current drop intensity.

9. The operating method of claim 8, wherein the adaptively shifting the drop intensity includes
comparing loss reduction according to a reduced drop intensity and loss reduction according to an increased drop intensity while alternately using the reduced drop intensity and the increased drop intensity for a certain number of iterations, and updating the current drop intensity in a significantly better direction of the loss reduction.

10. An apparatus for online continual learning, the apparatus comprising:
a memory; and
a processor executing instructions stored in the memory,
wherein the processor is configured, by executing the instructions, to:
fuse at least some feature maps generated by layers of a target model performing online continual learning to generate a fused feature map;
identify features with high attention in the fused feature map as shortcut features in a ratio based on a drop intensity; and
remove the shortcut features from a target feature map output from a predetermined layer of the target model and input to a next layer.

11. The apparatus of claim 10, wherein the next layer of the predetermined layer receives a feature map with the shortcut features removed as input, so that shortcut debiasing online continual learning is progressed in the target model.

12. The apparatus of claim 10, wherein the processor is configured to
remove the shortcut features from the target feature map by applying a drop mask that masks regions of the shortcut features in the target feature map with zero.

13. The apparatus of claim 10, wherein the processor is configured to
fuse a first feature map including structural information with a second feature map including semantic information.

14. The apparatus of claim 13, wherein the processor is configured to
adjust the first feature map and the second feature map to have the same resolution and then fuses the first feature map and the second feature map.

15. The apparatus of claim 10, wherein the processor is configured to:
perform pooling on the fused feature map along channel dimension to generate an attention map;
identify a certain percentage of features with high attention scores in the attention map as the shortcut features based on the drop intensity; and
generate a drop mask that masks regions of the shortcut features in the attention map with zero.

16. The apparatus of claim 10, wherein the processor is configured to adaptively shift the drop intensity.

17. The apparatus of claim 16, wherein the processor is configured to
periodically determine whether decrement or increment of a current drop intensity is beneficial to prediction performance of the target model, and increase or decrease a next drop intensity from the current drop intensity, or maintains the current drop intensity.

18. The apparatus of claim 17, wherein the processor is configured to:
compare loss reduction according to a reduced drop intensity and loss reduction according to an increased drop intensity while alternately using the reduced drop intensity and the increased drop intensity for a certain number of iterations; and
update the current drop intensity in a significantly better direction of the loss reduction.

19. A computer program stored in a non-transitory computer-readable storage medium, the computer program comprising instructions that, when executed by at least one processor, cause the processor configured to:
fuse at least some feature maps generated by layers of a target model performing online continual learning to generate a fused feature map;
perform pooling on the fused feature map along a channel to generate an attention map;
identify a certain percentage of features with high attention scores in the attention map as the shortcut features based on the drop intensity;
generate a drop mask that masks regions of the shortcut features in the attention map with zero; and
apply the drop mask to a target feature map output from a predetermined layer of the target model, and input a new target feature map with shortcut features removed into a next layer of the predetermined layer.

20. The computer program of claim 19, further comprising instructions to cause the processor configured to
periodically determine whether decrement or increment of a current drop intensity is beneficial to prediction performance of the target model, and increase or decrease a next drop intensity from the current drop intensity, or maintain the current drop intensity.
